(19) United States
(12) Patent Application Publication
(10) Pub. No.: US 2012/0219663 A1
(43) Pub. Date: Aug. 30, 2012

(54) MILK - PLANT FAT - CURD CHEESE

(75) Inventors: Jon R. Gutknecht, Delray Beach, FL (US); John B. Ovitt, Franklin, VT (US)

(73) Assignee: FRANKLIN FOODS, INC., Delray Beach, FL (US)

(21) Appl. No.: 13/341,434

(22) Filed: Dec. 30, 2011

Related U.S. Application Data
(63) Continuation-in-part of application No. 13/037,292, filed on Feb. 28, 2011.

(51) Int. Cl. A23C 19/093; A23C 19/06; A23C 19/032

(52) U.S. Cl. 426/36; 426/582; 426/61

(57) ABSTRACT

Process includes: forming milk-plant fat composition including first amount of milk composition that includes milk fat and milk protein, and second amount of plant fat composition that includes plant fat; inoculating milk-plant fat composition with lactic acid-producing bacteria; culturing the bacteria; and separating milk-plant fat composition, forming milk-plant fat-curd cheese, and whey composition. Further in process, milk-plant fat composition has concentration by weight of total solids selected as being within range of between about 17% and about 21%. Additionally in process, milk-plant fat composition has first concentration by weight of milk protein and second concentration by weight of combined fats including milk fat and plant fat, wherein ratio of first concentration divided by second concentration is selected as being within range of between about 0.19 and about 0.26. Composition: milk-plant fat-curd cheese.

PRIORITY CLAIM

This application is a continuation-in-part of commonly-owned U.S. patent application Ser. No. 13/037,292, filed on Feb. 28, 2011, and entitled “Processes For Making Cheese Products Utilizing Denatured Acid Whey Proteins,” the entirety of which hereby is incorporated herein by reference.

### BACKGROUND OF THE INVENTION

1. Field of the Invention

The present invention relates to the field of cheese curd products, and processes for making cheese curd products that include culturing lactic acid-producing bacteria in a milk composition.

2. Background of the Invention

Cheese curd products are ubiquitous in modern diets. Cheese curd products may be made by processes that include inoculating a milk composition with lactic acid-producing bacteria, culturing the bacteria in the milk composition to form a curd and a whey, separating the curd from the whey, and recovering the cheese curd product. Despite the longstanding history of developments of cheese curd products and of such cheese-making processes, further improvements in cheese curd products and in processes for making such products are needed.

### SUMMARY

In an example of an implementation, a process is provided that includes: forming a milk-plant fat composition including a first amount of a milk composition that includes milk fat and milk protein, and including a second amount of a plant fat composition that includes plant fat; inoculating the milk-plant fat composition with lactic acid-producing bacteria; culturing the lactic acid-producing bacteria in the milk-plant fat composition; and separating the milk-plant fat composition, thereby forming a milk-plant fat-curd cheese, and a whey composition. In the process, the milk-plant fat composition has a concentration by weight of total solids selected as being within a range of between about 17% and about 21%. Also in the process, the milk-plant fat composition has a first concentration by weight of the milk protein and has a second concentration by weight of combined fats including the milk fat and the plant fat, wherein a ratio of the first concentration divided by the second concentration is selected as being within a range of between about 0.19 and about 0.26.

In some examples of implementations of the process, forming the milk-plant fat composition includes providing the milk composition as including aqueous, condensed, dry or reconstituted raw-, whole-, reduced-fat- or nonfat-milk, or cream.

In further examples of implementations of the process, forming the milk-plant fat composition includes providing the milk composition as including: a concentration by weight of milk fat being within a range of between about 52% and about 10%; and a concentration by weight of milk protein being within a range of between about 4% and about 2%; and a concentration by weight of water being within a range of between about 51% and about 36%.

In additional examples of implementations of the process, forming the milk-plant fat composition includes providing the plant fat composition as including the plant fat as being derived from seeds or fruit of: soy, corn, canola, sunflower, safflower, olive, peanut, cottonseed, sesame, almond, apricot, avocado, coconut, flax, grapeseed, hazelnut, palm, palm kernel, pine, poppy, pumpkin, rice bran, tea, walnut, wheat, hemp, acai, cashew, chia, pecan, or hazelnut

In other examples of implementations of the process, forming the milk-plant fat composition includes selecting the concentration by weight of total solids as being: within a range of between about 18% and about 20%; or within a range of between about 18.5% and about 19.5%.

In some examples of implementations of the process, forming the milk-plant fat composition includes selecting the ratio of the first concentration divided by the second concentration as being: within a range of between about 0.20 and about 0.22; or within a range of between about 0.21 and about 0.22.

In further examples of implementations of the process, forming the milk-plant fat composition includes forming the milk-plant fat composition as including a third amount of a concentrated milk protein source, the third amount being suitable for adjusting the ratio of the first concentration divided by the second concentration as being within the range of between about 0.19 and about 0.26.

In additional examples of implementations of the process, forming the milk-plant fat composition includes selecting the second amount of the plant fat composition as being less than or equal to about 60% by weight of the milk-plant fat composition.

In other examples of implementations of the process, forming the milk-plant fat composition includes selecting the first amount of the milk composition as causing the milk-plant fat composition to have a concentration by weight of the milk fat being at least about 5% by weight.

In some examples of implementations of the process, forming the milk-plant fat composition includes providing the first amount of the milk composition at a first temperature being at least about 20 degrees Fahrenheit (° F.) above a melting point of the milk composition, and providing the second amount of the plant fat composition at a second temperature being at least about 20° F. above a melting point of the plant fat composition; and then combining together the milk composition and the plant fat composition.

In further examples of implementations of the process, forming the milk-plant fat composition includes carrying out the combining of the first amount of the milk composition together with the second amount of the plant fat composition with a difference between the first and second temperatures being about 5° F. or less.

In additional examples of implementations of the process, forming the milk-plant fat composition includes providing the second amount of the plant fat composition at the second temperature as being within a range of between a pasteurization temperature and a temperature being about 20° F. above the melting point of the plant fat composition.

In other examples of implementations of the process, forming the milk-plant fat composition includes providing the second amount of the plant fat composition at the second temperature as being within a range of between about 20° F. to about 40° F. above the melting point of the plant fat composition.

In some examples of implementations of the process, forming the milk-plant fat composition includes providing the second amount of the plant fat composition at the second temperature as being within a range of between about 28° F. to about 33° F. above the melting point of the plant fat composition.

In further examples of implementations of the process, forming the milk-plant fat composition includes providing the plant fat composition as including palm oil having a melting point being within a range of between about 91° F. and about 102° F., and includes providing the second amount of the plant fat composition at the second temperature as being within a range of between about 125° F. and about 130° F.

In additional examples of implementations of the process, forming the milk-plant fat composition includes providing the first amount of the milk composition and providing the second amount of the plant fat composition; and then combining together the milk composition and the plant fat composition.

In other examples of implementations, the process includes at least semi-continuously providing the milk composition and the plant fat composition; and then at least semi-continuously combining together batches each including the first amount of the milk composition and including the second amount of the plant fat composition

In some examples of implementations of the process, inoculating the milk-plant fat composition with the lactic acid-producing bacteria includes inoculating the milk-plant fat composition with live and active lactic acid-producing mesophilic bacteria.

In further examples of implementations of the process, inoculating the milk-plant fat composition with the lactic acid-producing bacteria includes inoculating the milk-plant fat composition with live and active mesophilic bacteria of a strain that includes: Lactococcus-lactis-lactis-diacetylactis, Leuconostoc mesenteroides cremoris, Lactococcus-lactis-lactis, Lactococcus-lactis-cremoris, or Lactobacillus helveticus.

In additional examples of implementations of the process, forming the milk-plant fat composition includes forming the milk-plant fat composition as having an initial pH; wherein the forming the milk-plant fat-curd cheese and the whey composition includes carrying out the separating the milk-plant fat composition when the initial pH has been reduced to being: within a range of between about 4.9 and about 4.5; or within a range of between about 4.80 and about 4.75.

In other examples of implementations of the process, separating the milk-plant fat composition includes forming the milk-plant fat-curd cheese as including at least about 70% by weight of the milk protein and including at least about 95% by weight of the combined fats.

In some examples of implementations of the process, separating the milk-plant fat composition includes forming the milk-plant fat-curd cheese as including at least about 75% by weight of the milk protein and including at least about 99% by weight of the combined fats.

In further examples of implementations, the process includes combining together the milk-plant fat-curd cheese and an amount of an edible acid being suitable for reducing a pH of the milk-plant fat-curd cheese to being within a range of between about 4.7 and about 4.6.

In additional examples of implementations, the process includes providing the milk-plant fat-curd cheese made according to the process.

In another example of an implementation, a composition is provided, including a milk-plant fat-curd cheese that includes a milk-plant fat composition having a first concentration by weight of milk protein and a second concentration by weight of combined fats including milk fat and plant fat, wherein a ratio of the first concentration divided by the second concentration is within a range of between about 0.19 and about 0.26, and wherein the milk-plant fat composition includes lactic acid-producing bacteria.

In some examples of implementations of the composition, the ratio of the first concentration divided by the second concentration is: within a range of between about 0.20 and about 0.22; or within a range of between about 0.21 and about 0.22.

In further examples of implementations of the composition, the milk-plant fat-curd cheese includes a concentration by weight of milk fat of at least about 5%.

In additional examples of implementations of the composition, the plant fat includes a plant fat derived from seeds or fruit of: soy, corn, canola, sunflower, safflower, olive, peanut, cottonseed, sesame, almond, apricot, avocado, coconut, flax, grapeseed, hazelnut, palm, palm kernel, pine, poppy, pumpkin, rice bran, tea, walnut, wheat, hemp, acai, cashew, chia, pecan, or hazelnut.

In other examples of implementations of the composition, the lactic acid-producing bacteria are of a mesophilic strain that includes: Lactococcus-lactis-lactis-diacetylactis, Leuconostoc mesenteroides cremoris, Lactococcus-lactis-lactis, Lactococcus-lactis-cremoris, or Lactobacillus helveticus.

Other processes, products, features and advantages of the invention will be or will become apparent to one with skill in the art upon examination of the following figures and detailed description. It is intended that all such additional processes, products, features and advantages be included within this description, be within the scope of the invention, and be protected by the accompanying claims.

### BRIEF DESCRIPTION OF THE FIGURES

The invention can be better understood with reference to the following FIGURE.

FIG. 1 is a flow chart showing an example of an implementation of a process [100] for making a milk-plant fat-curd cheese.

### DETAILED DESCRIPTION

Processes are provided herein that include: forming a milk-plant fat composition including a first amount of a milk composition that includes milk fat and milk protein, and including a second amount of a plant fat composition that includes plant fat; inoculating the milk-plant fat composition with lactic acid-producing bacteria; culturing the lactic acid-producing bacteria in the milk-plant fat composition; and separating the milk-plant fat composition, thereby forming a milk-plant fat-curd cheese and a whey composition. Forming the milk-plant fat composition in the processes further includes selecting a concentration by weight of total solids as being within a range of between about 17 percent (%) and about 21%. In addition, the processes include: forming the milk-plant fat composition as having a first concentration by weight of the milk protein and having a second concentration by weight of combined fats including the milk fat and the plant fat; and selecting a ratio of the first concentration divided by the second concentration as being within a range of between about 0.19 and about 0.26.

The processes provided herein include forming the milk-plant fat composition in accordance with both of these two ranges: (1) the concentration by weight of total solids of the milk-plant fat composition is within a range of between about 17% and about 21%; and (2) a ratio of the concentration by weight of the milk protein divided by the concentration by weight of combined fats including the milk fat and the plant fat is within a range of between about 0.19 and about 0.26. The combination of these two ranges together in the processes provided herein facilitates making a milk-plant fat-curd cheese containing high percentages by weight of the milk protein, the milk fat, and the plant fat that are included in the milk-plant fat composition; and facilitates making a dilute aqueous whey composition containing correspondingly low percentages by weight of such milk protein, milk fat, and plant fat. For example, the processes herein may facilitate forming a milk-plant fat-curd cheese including, as derived from the milk-plant fat composition, at least about 70% by weight of the milk protein and at least about 95% by weight of the combined fats; and consequently forming a dilute aqueous whey composition including, as derived from the milk-plant fat composition, less than about 30% by weight of the milk protein and less than about 5% by weight of the combined fats.

Processes that include one or more deviations from these two ranges may yield a milk-plant fat-curd cheese of inferior quality, and may result in forming a whey composition containing, as derived from the milk-plant fat composition, an excessive percentage by weight of the milk protein or a substantial percentage by weight of the combined fats. Throughout this specification, the term “excessive percentage” of the milk protein derived from a milk-plant fat composition means, by weight, more than about 30%. Throughout this specification, the term “substantial percentage” of combined fats derived from a milk-plant fat composition means, by weight, more than about 1%. As examples, the milk-plant fat-curd cheese may have an excessively hard and dry texture, and the whey composition may have a white appearance and contain a substantial concentration of milk protein, upon deviating from either or both of these two ranges such that: (1) the concentration by weight of total solids of the milk-plant fat composition is greater than about 21%; and (2) in the milk-plant fat composition, the ratio of the concentration by weight of the milk protein divided by the concentration by weight of combined fats including the milk fat and the plant fat is greater than about 0.26. As further examples, the milk-plant fat-curd cheese may have an excessively soft, moist and runny texture, and the whey composition may have a cloudy appearance and contain a substantial concentration of the combined fat, upon deviating from either or both of these two ranges such that (1) the concentration by weight of total solids of the milk-plant fat composition is less than about 17%; and (2) in the milk-plant fat composition, the ratio of the concentration by weight of the milk protein divided by the concentration by weight of combined fats including the milk fat and the plant fat is less than about 0.19. Milk protein is hygroscopic and generally has a somewhat crumbly, grainy, sticky, agglomerative texture. Accordingly, the texture and “mouth feel” of the milk-plant fat-curd cheese may be somewhat dry, grainy, and hard if the water concentration therein is too low relative to the concentration of the milk protein that is present. In addition, the texture and “mouth feel” of the milk-plant fat-curd cheese is also affected by a balance between the dry, crumbly texture of the milk protein and the fluidic, viscous texture of the combined fats. Therefore, making a milk-plant fat-curd cheese having a total solids concentration by weight being greater than about 21%, or having a milk protein/combined fats ratio being greater than about 0.26, may cause the resulting milk-plant fat-curd cheese to have a dry, grainy, hard texture due to the presence of excessive protein relative to the available water in the product. Likewise, making a milk-plant fat-curd cheese having a total solids concentration by weight being less than about 17%, or having a milk protein/combined fats ratio of less than about 0.19, may cause the resulting milk-plant fat-curd cheese to have an excessively moist, soft, runny texture due to the presence of too much water relative to the available protein in the product.

In examples, the processes provided herein may further include carrying out the separating of the milk-plant fat composition, and thereby forming the milk-plant fat-curd cheese and the whey composition, when an initial pH of the milk-plant fat composition has been reduced by the culturing to within a range of between about 4.9 and about 4.5. Where the separating of the milk-plant fat composition is instead carried out when the initial pH has been reduced by the culturing to a pH either being higher than about 4.9 or lower than about 4.5, the resulting whey composition may contain an excessive percentage by weight of the milk protein or a substantial percentage by weight of the combined fats, or both; and the resulting milk-plant fat-curd cheese may contain correspondingly reduced percentages by weight of either or both of the milk protein and the combined fats.

As further examples, forming the milk-plant fat composition in the processes herein may include providing the first amount of the milk composition at a first temperature being at least about 20° F. above a melting point of the milk composition, and may include providing the second amount of the plant fat composition at a second temperature being at least about 20° F. above a melting point of the plant fat composition; and may further include a difference between the first and second temperatures being about 5° F. or less. Providing the milk composition and the plant fat composition, respectively, at first and second temperatures being at least about 20° F. above melting points of the respective compositions, may facilitate combining them together. Furthermore, providing the milk composition and the plant fat composition, respectively, at such a first temperature and at a second temperature being within about 5° F. or less of the first temperature, may also facilitate combining them together. For example, providing the milk composition and the plant fat composition at such temperatures may minimize or avoid, during the combining or later in the process [100], agglomeration or precipitation of the plant fat composition. Processes that deviate from providing the milk composition and the plant fat composition at such temperatures may yield a milk-plant fat-curd cheese of inferior quality. For example, where the first and second temperatures are not at least about 20° F. above the respective melting points or where the first temperature is not within about 5° F. or less of the second temperature, the plant fat composition may form a globular gel phase remaining separate from the milk composition being another phase.

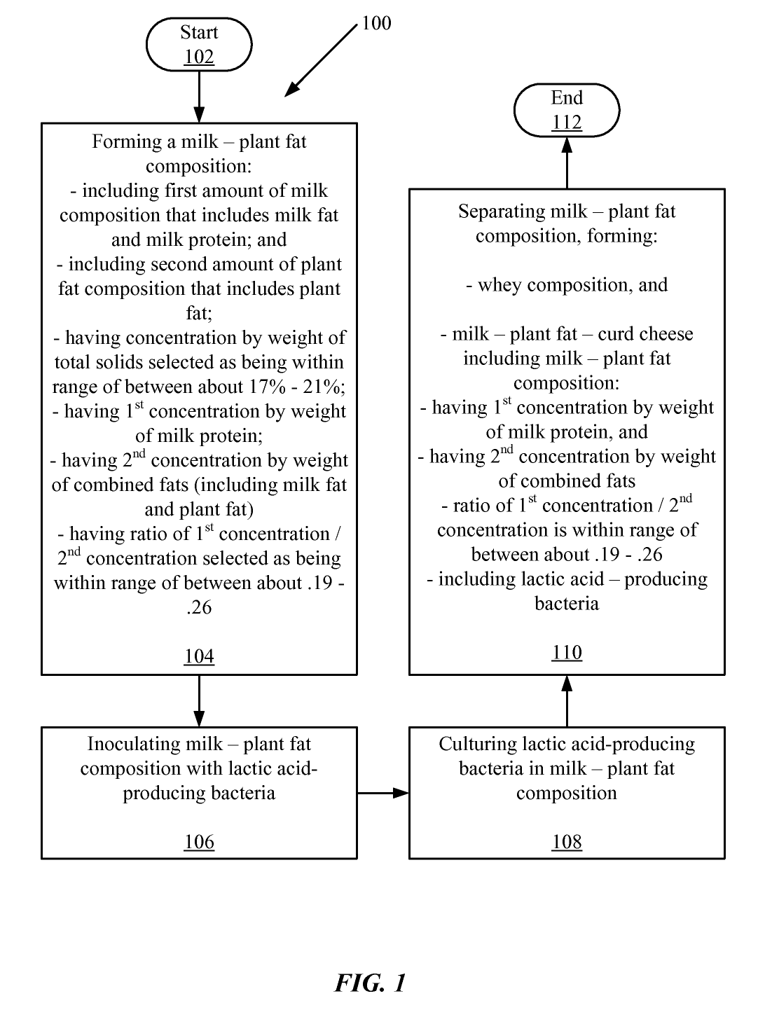

FIG. 1 is a flow chart showing an example of an implementation of a process [100] for making a milk-plant fat-curd cheese. The process [100] starts at step [102]; and then step [104] includes forming a milk-plant fat composition including: a first amount of a milk composition that includes milk fat and milk protein; and a second amount of a plant fat composition that includes plant fat. Throughout this specification, all concentrations are expressed by weight, and all weights and concentrations are measured and expressed at an ambient room temperature of about 70 degrees Fahrenheit (° F.) and a pressure of one standard atmosphere (760 Torr). Throughout this specification, all temperatures are also measured at a pressure of one standard atmosphere.

Throughout this specification, the term “milk composition” means an aqueous composition having components that include water, lactose sugars, milk fat and milk protein, wherein the aqueous composition includes one or more sources of such milk fat and milk protein, examples of such sources including aqueous, condensed, dry or reconstituted raw-, whole-, reduced-fat- or nonfat-milk, or cream. As an example, these sources may be derived from cow milk. Among these sources of milk fat and milk protein are, as examples: raw milk, cream, whole milk, reduced-fat milk, skim (non-fat) milk, non-fat dry milk (“NFDM”), dry cream, dry whole milk, dry reduced-fat milk, dry nonfat milk, condensed cream, condensed whole milk, condensed reduced-fat milk, condensed nonfat milk, and reconstituted milk. Throughout this specification, the term “fat” means a composition including triglycerides, triacylglycerols, diglycerides, monoacylglycerols, or fatty acids. Throughout this specification, the term “milk fat” means the lipid components of edible milk, for example, of cow milk. These lipids may include, as examples, triacylglycerols, diglycerides, and monoacylglycerols. Throughout this specification, the term “milk protein” means the combined protein components of edible milk, for example, of cow milk. Throughout this specification, the terms “casein protein” and “whey protein” mean the casein protein and whey protein components of edible milk, for example, of cow milk. As examples, the milk composition may include: a concentration by weight of milk fat being within a range of between about 52% and about 10%; and a concentration by weight of milk protein being within a range of between about 4% and about 2%; and a concentration by weight of water being within a range of between about 51% and about 36%.

Throughout this specification, the term “plant fat” means an edible plant-derived fat. Plant fats may for example include triglycerides, which are tri-esters of glycerol and fatty acids. A plant fat having a melting point at or below an ambient room temperature may also be referred to as being a “plant oil.” Throughout this specification, the term “melting point” means the temperature at which or the range of temperatures over which the physical state of a composition changes from being a solid to being a liquid. For example, palm oil generally has a melting point within or over a range of between about 91° F. and about 102° F. In general, plant oils, as well as other plant fats having melting points above ambient room temperatures, may be utilized in step [104] of the process [100]. As examples, the plant fat composition may include one or more plant fats each having melting points being about 75° F. or less. Throughout this specification, the term “plant fat composition” means an edible plant-derived composition that includes a plant fat. A plant fat composition may include, as examples, a total concentration by weight of one or more plant fats being within a range of between about 85% and about 100%; or being about 100%. Examples of plant fats that may be utilized in step [104] herein include plant fats derived from seeds or fruit of: soy, corn, canola, sunflower, safflower, olive, peanut, cottonseed, sesame, almond, apricot, avocado, coconut, flax, grapeseed, hazelnut, palm, palm kernel, pine, poppy, pumpkin, rice bran, tea, walnut, wheat, hemp, acai, cashew, chia, pecan, or hazelnut.

In forming the milk-plant fat composition at step [104] of the process [100], the milk-plant fat composition has a concentration by weight of total solids selected as being within a range of between about 17% and about 21%. Throughout this specification, the term “total solids” designates the components of an aqueous composition that remain after subtraction of the water from the composition. The concentration by weight of water in the milk-plant fat composition may be qualitatively correlated with the firmness of the milk-plant fat composition. Firmness of the milk-plant fat composition may be determined in accordance with the American Oil Chemists' Society (“AOCS”) Official Method Cc-16-60, utilizing a penetrometer. For example, a Humboldt H-1200 Penetrometer may be utilized. In further examples, forming the milk-plant fat composition at step [104] includes selecting the concentration by weight of total solids as being within a range of between about 18% and about 20%; or within a range of between about 18.5% and about 19.5%. As an example, selecting the concentration by weight of total solids of the milk-plant fat composition as being within the range of between about 17% and about 21% may include adjusting the first amount of the milk composition relative to the second amount of the plant fat composition.

In further examples, selecting the concentration by weight of total solids of the milk-plant fat composition as being within the range of between about 17% and about 21% may include selecting a concentration by weight of water in the milk composition. The concentration by weight of water in the milk composition may be quantitatively determined, for example, by measured microwave dielectric spectra. For example, the concentration by weight of water in a milk composition may be quantitatively determined, by utilizing a SMART System5 Microwave Moisture/Solids Analyzer as may be commercially available from CEM Corporation, having an address at 3100 Smith Farm Road, Matthews, N.C. 28104 USA; www.cem.com. As another example, methods for determining the water content of foods by microwave dielectric spectra are disclosed in: Daschner, F. et al., “Optimization of the microwave determination of water in foods using principal component analysis,” Instrumentation and Measurement Technology Conference 2000 (IMTC 2000; Proceedings of the 17^{th} IEEE), May 1-4, 2000, Vol. 1 pp. 12-16, version published 6 Aug. 2002, the entirety of which hereby is incorporated herein by reference.

As additional examples, selecting the concentration by weight of total solids of the milk-plant fat composition as being within the range of between about 17% and about 21% may include providing a concentrated milk protein source as being included in the milk composition. Throughout this specification, the term “concentrated milk protein source” means a composition having components that include casein protein or whey protein or both casein protein and whey protein, wherein the composition contains less milk fat than whole milk. In examples, providing a concentrated milk protein source as included in the first amount of the milk composition at step [104] of the process [100] may include providing the concentrated milk protein source as including: aqueous nonfat (skim) milk; condensed nonfat milk; dry nonfat milk; or reconstituted nonfat milk. Examples of concentrated milk protein sources include the following, which may be in aqueous form, in condensed form, in dry form, or in reconstituted aqueous form: nonfat milk; whey protein concentrate (“WPC”); casein protein and whey protein concentrate (“MPC”); whole casein protein; whole whey protein; acid whey protein; casein protein curd; and whey protein curd. Throughout this specification, the term “reconstituted” means an aqueous milk composition including a dry milk component having been combined together with water. Nonfat dry milk may also be referred to as “NFDM”. As examples, NFDM may be reconstituted by combining the NFDM together with water or with aqueous nonfat milk. WPC and MPC may be produced, as examples, by ultrafiltration of a milk composition. WPC compositions having protein concentrations by weight of about 30%, about 50%, and about 85%, as examples, may be commercially available. As an example, these concentrated milk protein sources may be derived from cow milk. Further, for example, one or more concentrated milk protein sources may be utilized in combination together in providing the first amount of the milk composition as having a selected concentration by weight of water and having a corresponding concentration by weight of total solids.

In forming the milk-plant fat composition at step [104] of the process [100], the milk-plant fat composition also has a first concentration by weight of the milk protein and a second concentration by weight of combined fats including the milk fat and the plant fat, wherein a ratio of the first concentration divided by the second concentration is selected as being within a range of between about 0.19 and about 0.26. As further examples, the ratio of the first concentration divided by the second concentration may be selected as being within a range of between about 0.20 and about 0.22; or as being within a range of between about 0.21 and about 0.22. In an additional example, the ratio of the first concentration divided by the second concentration may be upwardly adjusted to be within the range of between about 0.19 and about 0.26 by supplementing the milk composition with a suitable third amount of a concentrated milk protein source. Further, for example, the ratio of the first concentration divided by the second concentration may be downwardly adjusted to be within the range of between about 0.19 and about 0.26 by supplementing the milk-plant fat composition with a suitable additional amount of a plant fat composition or of a milk composition containing milk fat.

In further examples, forming the milk-plant fat composition at step [104] of the process [100] may include selecting the first amount of the milk composition and the second amount of the plant fat composition so that after separating the milk-plant fat composition, the milk-plant fat curd cheese has a concentration by weight of water being: within a range of between about 49% and about 57%; or within a range of between about 50% and about 55%. In such further examples, the milk-plant fat curd cheese has a corresponding concentration by weight of total solids being: within a range of between about 51% and about 43%; or within a range of between about 50% and about 45%. As examples, forming the milk-plant fat composition at step [104] with the concentration by weight of total solids being within the range of between about 17% and about 21% and with the ratio of the first concentration divided by the second concentration being within the range of between about 0.19 and about 0.26, may result in the milk-plant fat curd cheese having a concentration by weight of total solids being within the range of between about 51% and about 43%. For example, a milk-plant fat curd cheese having a concentration by weight of water being within a range of between about 49% and about 57% may have a single, homogeneous phase with a viscosity and body comparable to that of conventional cream cheese. For example, a milk-plant fat curd cheese having a concentration by weight of water being less than about 49% may have a rubbery texture due to the presence of inadequate water. Furthermore, for example, a milk-plant fat curd cheese having a concentration by weight of water being more than about 57% may have an excessively moist, soft, runny texture due to the presence of too much water. The concentration by weight of water in the milk-plant fat curd cheese may be quantitatively determined, for example, by measured microwave dielectric spectra. For example, the concentration by weight of water in the milk-plant fat curd cheese may be quantitatively determined by utilizing a SMART System5 Microwave Moisture/Solids Analyzer as earlier discussed.

The concentration by weight of milk fat in the milk composition may be measured, for example, using the Gerber test, as defined in “GEA Niro Method No. A 9 b, “Total Fat by Gerber/Teichert”, revised September 2005, published on-line at www.niro.com, the entirety of which hereby is incorporated herein by reference. The concentration of milk fat in the milk composition may also be measured, for example, using a standard Babcock test. For background, see Baldwin, R. J., “The Babcock Test,” Michigan Agricultural College, Extension Division, Bulletin No. 2, Extension Series, March 1916, pp. 1-11; the entirety of which hereby is incorporated herein by reference. The concentration by weight of milk protein in the milk composition may be measured, for example, using the “Protein Nitrogen Content of Milk Kjeldahl Direct Method”, June 1991, published on-line by the United States Department of Agriculture at www.fmmaseattle.com, the entirety of which hereby is incorporated herein by reference.

In an additional example, forming the milk-plant fat composition at step [104] of the process [100] may include selecting the second amount of the plant fat composition as being less than or equal to about 60% by weight of the milk-plant fat composition. As further examples, the second amount of the plant fat composition may be selected as being less than or equal to about 55% by weight, or as being within a range of between about 50% by weight and about 55% by weight, of the milk-plant fat composition. As an additional example, forming the milk-plant fat composition may include selecting the first amount of the milk composition as being about 94% by weight of the milk-plant fat composition, and selecting the second amount of the plant fat composition as being about 6% by weight of the milk-plant fat composition. As another example, forming the milk-plant fat composition at step [104] of the process [100] may include selecting the first amount of the milk composition as causing the milk-plant fat composition to have a concentration by weight of the milk fat being at least about 5% by weight. In further examples, the milk-plant fat composition may be standardized as having a concentration by weight of combined fat being within a range of between about 11% and about 13%, or as having a concentration by weight of about 12%. In those further examples, the resulting milk-plant fat-curd cheese may contain the combined fats at a concentration by weight of about 33%. In an additional example, forming a milk-plant fat composition having a combined fat concentration by weight of about 12% may include selecting the first amount of the milk composition as constituting about 93.4% by weight of the milk-plant fat composition and as resulting in a milk fat concentration by weight of about 5.4% in the milk-plant fat composition, and selecting the second amount of the plant fat composition as constituting about 6.6% by weight of the milk-plant fat composition. Forming a milk-plant fat composition including a plant fat composition at a concentration by weight of greater than about 60% may cause a residual portion of the plant fat composition to agglomerate, precipitate, or settle out of the milk-plant fat composition or otherwise form a phase being separated from a phase of the milk composition during the process [100]. In an additional example, a concentration by weight of water in the milk-plant fat composition may be selected as being less than or equal to about 55%; or may be selected as being within a range of between about 50% and about 55%.

In examples, forming the milk-plant fat composition at step [104] of the process [100] may include: providing the first amount of the milk composition at a first temperature being at least about 20° F. above a melting point of the milk composition, and may include providing the second amount of the plant fat composition at a second temperature being at least about 20° F. above a melting point of the plant fat composition; and then combining together the first amount of the milk composition and the second amount of the plant fat composition. Providing the milk composition and the plant fat composition respectively being at such first and second temperatures may facilitate combining such compositions together. For example, providing the milk composition and the plant fat composition at such temperatures may minimize, during the combining or later in the process [100], agglomeration or precipitation of the plant fat composition. As examples, where the first and second temperatures are not both at least about 20° F. above the respective melting points of the compositions, then the plant fat composition may form a globular gel phase remaining separate from another phase of the milk composition. In additional examples, forming the milk-plant fat composition at step [104] may include: carrying out the combining of the first amount of the milk composition at the first temperature, together with the second amount of the plant fat composition at the second temperature, with a difference between the first and second temperatures being about 5° F. or less. Providing the milk composition and the plant fat composition at first and second temperatures where a difference between the first and second temperatures is about 5° F. or less may also facilitate combining such compositions together as forming such a single, homogeneous phase, and may contribute to minimizing agglomeration or precipitation of the plant fat composition during the combining or later in the processes. In further examples of the process [100], forming the milk-plant fat composition at step [104] may include providing the second amount of the plant fat composition at the second temperature as being within a range of between a pasteurization temperature and a temperature being about 20° F. above the melting point of the plant fat composition. Throughout this specification, the term “pasteurization temperature” generally means a temperature within a range of between about 150° F. and about 170° F. In those further examples, forming the milk-plant fat composition at step [104] may likewise include providing the first amount of the milk composition at the first temperature as being within a range of between a pasteurization temperature and a temperature being about 20° F. above the melting point of the milk composition; and may include a difference between the first and second temperatures being about 5° F. or less. In additional examples of the process [100], forming the milk-plant fat composition at step [104] may include providing the second amount of the plant fat composition at the second temperature as being: within a range of between about 20° F. to about 40° F. above the melting point of the plant fat composition, or within a range of between about 28° F. to about 33° F. above the melting point of the plant fat composition. In those additional examples, forming the milk-plant fat composition at step [104] may likewise include providing the first amount of the milk composition at the first temperature as being: within a range of between about 20° F. to about 40° F. above the melting point of the milk composition, or within a range of between about 28° F. to about 33° F. above the melting point of the milk composition; and may include a difference between the first and second temperatures being about 5° F. or less. In other examples of the process [100], forming the milk-plant fat composition at step [104] may include providing the plant fat composition as containing palm oil having a melting point being within a range of between about 91° F. and about 102° F.; and may include providing the second amount of the plant fat composition at the second temperature as being within a range of between about 125° F. and about 130° F., or as being about 128° F. In those other examples, forming the milk-plant fat composition at step [104] may likewise include providing the first amount of the milk composition at the first temperature as being within a range of between about 125° F. and about 130° F., or as being about 128° F.

As a further example, forming the milk-plant fat composition at step [104] of the process [100] may include providing the first amount of the milk composition and providing the second amount of the plant fat composition; and then combining together the first and second amounts. As an example, the second amount of the plant fat composition may be gradually mixed into the first amount of the milk composition. The mixing may, for example, further include homogenizing the milk-plant fat composition by subjecting it simultaneously to an elevated pressure and temperature. In an example, the milk-plant fat composition may be homogenized for about two (2) seconds by a two-stage procedure including an initial second-stage homogenization under a pressure of at least about five hundred (500) pounds per square inch (“PSI”), followed by a first-stage homogenization under a pressure within a range of between about one thousand (1,000) PSI and about five thousand (5,000) PSI, or a pressure of about two thousand (2,000) PSI. As the selected pressure to be applied to the milk-plant fat composition is increased, the resulting viscosity of the milk-plant fat composition and of the final milk-plant fat-curd cheese may also accordingly be increased. Homogenization may, for example, be facilitated by being carried out with the milk-plant fat composition being at an elevated temperature, such as a temperature of about 130° F. The elevated pressure may be generated by hydraulic or mechanical force, as examples. In one example, homogenization may include confining the milk-plant fat composition at a selected pressure in a closed pressurized chamber and then allowing the milk-plant fat composition to escape from the chamber through an orifice to quickly release the pressure. For example, a Gaulin homogenizer may be utilized. In general, carrying out the homogenization at an elevated temperature may increase the fluidity of the milk-plant fat composition, thereby improving the flow of the milk-plant fat composition out from the pressurized chamber.

In an example, homogenizing the milk-plant fat composition at step [104] may be carried out utilizing a homogenizer apparatus having an inlet chamber, a homogenization chamber, and an outlet chamber. In this example, the inlet chamber may be a vessel suitable for staging a supply of the milk-plant fat composition, on a continuous or batch basis, for introduction into the homogenization chamber. The homogenization chamber in this example may be a vessel having controllable orifices for input and output of the milk-plant fat composition, and may be reinforced to withstand containment of an elevated pressure suitable for homogenization. Further in this example, the outlet chamber may be a vessel suitable for staging a supply of the homogenized milk-plant fat composition, on a continuous or batch basis, for further steps in the process [100]. In operation of this example of a homogenizer apparatus, the milk-plant fat composition may pass through the inlet chamber before being pumped into the homogenization chamber. Following homogenization, the milk-plant fat composition may be expelled from the homogenization chamber into the outlet chamber. For example, these flows may be carried out on a continuous basis, although a batch process may also be done. A pressure within the homogenization chamber may, for example, be adjusted to a selected homogenization pressure and so maintained during homogenization. In an example, the homogenization chamber may be configured for subjecting the milk-plant fat composition to the two-stage homogenization discussed earlier, including an initial second-stage homogenization under a pressure of at least about five hundred (500) PSI followed by a first-stage homogenization under a pressure within a range of between about one thousand (1,000) PSI and about five thousand (5,000) PSI, or a pressure of about two thousand (2,000) PSI. The pressure in the inlet chamber may be, for example, within a range of between about twenty (20) PSI and about forty (40) PSI, generated by pumping of the milk-plant fat composition into the inlet chamber. Similarly, the pressure in the outlet chamber may be, for example, within a range of between about twenty (20) PSI and about forty (40) PSI, generated by expelling the milk-plant fat composition from the homogenization chamber and then containing it in the outlet chamber. The milk-plant fat composition may undergo a pressure drop upon passing from the homogenization chamber to the outlet chamber, by ejection through an orifice, such as for example an orifice having a diameter of about a centimeter. The pressures within the inlet chamber, outlet chamber and homogenization chamber may be carefully controlled, as an example, to avoid entrainment of air into the homogenization chamber. Air entrainment into the homogenization chamber may cause cavitation, which may degrade the milk-plant fat composition and may potentially lead to an explosive release of the homogenization pressure.

In another example, step [104] of the process [100] may include pasteurizing the milk-plant fat composition. As an alternative example, step [104] may include separately pasteurizing the milk composition and the plant fat composition prior to forming the milk-plant fat composition. The milk-plant fat composition is generally in a pasteurized condition when it is inoculated at step [106] with lactic acid-producing bacteria, so that the culturing at step [108] does not facilitate spoilage of the milk-plant fat composition by unintended growth of the wild bacteria and other microbes normally present in unpasteurized milk compositions and which may also be present in unpasteurized plant fat compositions. Effective pasteurization is a function of both time and temperature; pasteurization may be completed at higher temperatures in correspondingly shorter times. As examples, pasteurization of the milk-plant fat composition may be carried out by a vat process at a temperature within a range of between about 150° F. and about 170° F. for about thirty (30) minutes; or at a temperature of about 165° F. for about twenty (20) minutes. High temperature short time pasteurization, in which the milk-plant fat composition is pumped through an in-line tube within a temperature-controlled shell, may also be utilized. For example, high temperature/short time pasteurization may be carried out at a temperature of about 170° F. for a time period of about seventeen (17) seconds. The pasteurization may, for example, be carried out with agitation of the milk-plant fat composition to facilitate uniform heating throughout the milk-plant fat composition. In general, moderate agitation may be utilized to avoid excessive shear which may degrade the milk-plant fat composition. The force applied by the agitation generally should not be so strong as to substantially shear and thus degrade the milk fat, milk protein, and plant fat in the milk-plant fat composition. In examples, the pasteurization may be carried out in a tank equipped with a heater and agitator, such as a Groen kettle.

As another example, step [104] of the process [100] may include at least semi-continuously, or continuously, carrying out the forming of the milk-plant fat composition. For example, step [104] of the process [100] may include at least semi-continuously, or continuously providing the milk composition and the plant fat composition; and then at least semi-continuously, or continuously combining together batches each including the first amount of the milk composition and the second amount of the plant fat composition. In this manner, the process [100] may be carried out, for example, on a continuous or semi-continuous series of multiple batches each including the first amount of the milk composition and the second amount of the plant fat composition. The process conditions may accordingly be continuously or periodically monitored to maintain the concentration by weight of total solids of the milk-plant fat composition as being within the range of between about 17% and about 21%; and to maintain the ratio of the concentration by weight of the milk protein divided by the concentration by weight of combined fats including the milk fat and the plant fat as being within the range of between about 0.19 and about 0.26.

At step [106] of the process [100], the milk-plant fat composition is inoculated with lactic acid-producing bacteria; and at step [108] of the process [100], the lactic acid-producing bacteria are cultured in the milk-plant fat composition. In an example, the lactic acid-producing bacteria may be cultured in the milk-plant fat composition until an initial pH of the milk-plant fat composition is reduced to within a range of between about 4.9 and about 4.5. Throughout this specification, the term “initial pH” means the pH of the milk-plant fat composition that is formed at step [104] of the process [100]. The pH of the milk-plant fat composition may be measured and monitored using a pH meter, such as a Fisher Scientific pH meter. As another example, the lactic acid-producing bacteria may be cultured in the milk-plant fat composition until the initial pH of the milk-plant fat composition is reduced to within a range of between about 4.80 and about 4.75.

In an example, step [106] may include inoculating the milk-plant fat composition with at least one strain of live and active lactic acid-producing mesophilic bacteria suitable for being cultured in the milk-plant fat composition at step [108], thereby forming a milk-plant fat-curd cheese that may have a cream cheese-like flavor. For example, a strain of lactic acid-producing mesophilic bacteria may be selected that is known to produce diacetyl (also known as 2,3-butanedione), which contributes a “buttery” flavor to the milk-plant fat-curd cheese. Examples of diacetyl-producing strains of lactic acid-producing mesophilic bacteria that may be utilized include: Lactococcus-lactis-lactis-diacetylactis, and Leuconostoc mesenteroides cremoris. Additional examples of strains of lactic acid-producing mesophilic bacteria that may be utilized include: Lactococcus-lactis-lactis, Lactococcus-lactis-cremoris, and Lactobacillus helveticus. Suitable lactic acid-producing mesophilic bacteria strains may be commercially available under the trade name pHage Control™ from Chr. Hansen, Boge Allé 10-12, DK-2970 Horsholm, Denmark; and may include their commercial grades 604 and 608. Further suitable lactic acid-producing mesophilic bacteria strains may be commercially available under the trade names Flav Direct™ and DG™ Cultures, from Degussa BioActives, 620 Progress Avenue, P.O. Box 1609, Waukesha, Wis. 53187-1609.

The inoculating of the milk-plant fat composition with the lactic acid-producing bacteria at step [106] of the process [100] may include, either before or after the inoculating, adjusting the milk-plant fat composition to a temperature suitable for facilitating the culturing of the lactic acid-producing bacteria in the milk-plant fat composition at step [108]. As examples, the milk-plant fat composition may be adjusted to a temperature suitable for culturing of mesophilic bacteria being: within a range of between about 65° F. and about 92° F.; or within a range of between about 70° F. and about 85° F.; or within a range of between about 82° F. and about 84° F.; or about 82° F.

The milk-plant fat composition generally may be inoculated with a suitable amount of a composition containing live and active lactic acid-producing bacteria being selected at step [106]. As examples, the composition containing the selected live and active lactic acid-producing bacteria may be provided as a solution of the bacteria in a growth medium, constituting a “starter culture”; or may be provided as a highly-concentrated solution of the bacteria in a growth medium, constituting a “bulk starter culture.” As an alternative example, a portion of the milk-plant fat composition may be collected after the culturing is carried out at step [108], constituting a “mother culture,” and utilized for inoculating the milk-plant fat composition. However, utilization of a mother culture in step [106] of the process [100] may require careful monitoring to avoid growth of bacterio-phages. The inoculating of the milk-plant fat composition with lactic acid-producing bacteria at step [106] of the process [100] may further include agitating the milk-plant fat composition after combining together the milk-plant fat composition and the lactic acid-producing bacteria. In an example, a moderate shear force may be utilized, so as to efficiently disperse the lactic acid-producing bacteria in the milk-plant fat composition within a reasonable time, while avoiding excessive shear which may degrade the milk-plant fat composition or the lactic acid-producing bacteria. For example, the milk-plant fat composition may be subjected to moderate agitation for a time period within a range of between about ten (10) minutes and about twenty-five (25) minutes; or of about fifteen (15) minutes.

In step [108] of the process [100], the lactic acid-producing bacteria are cultured in the milk-plant fat composition. The duration of this bacteria culturing step depends on a plurality of factors, including the strain of bacteria utilized, the level of activity of the live bacteria, the selected culture temperature, the initial bacteria concentration, and the selected milk composition and plant fat composition that are included in the milk-plant fat composition. The bacteria digest the lactose sugars in the milk-plant fat composition, and produce lactic acid. Relatively high culture temperatures and relatively high initial bacteria concentrations generally shorten the culture time needed. The culture temperature employed, however, is generally within a range tolerable to the survival and growth of the selected culture bacteria. In one example, step [108] may include holding the milk-plant fat composition at a suitable temperature for cultures of the selected lactic acid-producing bacteria to grow for a sufficient time so that there is visible curd formation throughout the milk-plant fat composition, resulting in its substantial thickening. As examples, step [108] may include holding the milk-plant fat composition at a temperature suitable for culturing mesophilic bacteria, being: within a range of between about 65° F. and about 92° F.; or within a range of between about 70° F. and about 85° F.; or within a range of between about 82° F. and about 84° F.; or about 82° F. As further examples, live and active mesophilic bacteria may be cultured in the milk-plant fat composition for a time period within a range of between about seven (7) hours and about ten (10) hours.

Lactic acid is formed as a byproduct of metabolism of lactose sugars by the bacteria in step [108]. Hence, the measured pH of the milk-plant fat composition, which gradually decreases with lactic acid buildup, is an indication of the progress of the bacteria culture. Upon inoculating the milk-plant fat composition at step [106] with the lactic acid-producing bacteria, the initial pH of the milk-plant fat composition may be, for example, within a range of between about 6.8 and about 6.2. In step [108] of the process [100], the culturing of the bacteria may be continued, as an example, until the initial pH of the milk-plant fat composition has been reduced by a buildup of lactic acid to be: within a range of between about 4.9 and about 4.5; or within a range of between about 4.80 and about 4.75.

As the pH of the milk-plant fat composition approaches the final pH of the culturing of the bacteria in step [108], the viscosity of the milk-plant fat composition may significantly increase while the level of activity of the lactic acid-producing bacteria may significantly decrease. Hence, in an example, the pH of the milk-plant fat composition may be monitored during the culturing of the bacteria in step [108], and the inoculating of the milk-plant fat composition with the lactic acid-producing bacteria at step [106] may be repeated to reinvigorate the culturing of the bacteria in the milk-plant fat composition.

In another example, the culturing of the bacteria in step [108] of the process [100] may be concluded when the pH of the milk-plant fat composition has been reduced by a buildup of lactic acid to a pH being lower than the initial pH but still being higher than about 4.9; and the pH may then be further reduced by direct acidification to within a range of between about 4.9 and about 4.5, or to within a range of between about 4.80 and about 4.75. As an example, the direct acidification may be carried out after the culturing by then combining an appropriate amount of an edible acid with the milk-plant fat composition. Examples of suitable edible acids that may be utilized for directly acidifying the milk-plant fat composition after the culturing include lactic acid, phosphoric acid, acetic acid, and citric acid. For example, vinegar, being an aqueous solution of acetic acid, may be utilized. In an example, an aqueous mixture of edible acids that may be utilized, having a pH within a range of between about 0.08 and about 1.4, may be commercially available under the trade name Stabilac® 12 Natural from the Sensient Technologies Corporation, 777 East Wisconsin Avenue, Milwaukee, Wis. 53202-5304. As another example, similar edible acid mixtures may also be commercially available from Degussa Corporation, 379 Interpace Parkway, P.O. Box 677, Parsippany, N.J. 07054-0677. In an example, such direct acidification in step [108] after completion of the culturing may be carried out in a set tank internally equipped with a scraped surface agitator to ensure rapid and thorough mixing together of the edible acid and the milk-plant fat composition.

Step [110] of the process [100] includes separating the milk-plant fat composition, thereby forming a milk-plant fat-curd cheese and a whey composition. In examples, step [110] of the process [100] may include carrying out the separating of the milk-plant fat composition when the initial pH has been reduced to being within a range of between about 4.9 and about 4.5; or when the initial pH has been reduced to being within a range of between about 4.80 and about 4.75. As an example, separating the milk-plant fat composition may include forming the milk-plant fat-curd cheese as including, as derived from the first amount of the milk composition and the second amount of the plant fat composition utilized in forming the milk-plant fat composition, at least about 70% by weight of the milk protein and at least about 95% by weight of the combined fats. In further examples, separating the milk-plant fat composition may likewise include forming the milk-plant fat-curd cheese as including at least about 75% by weight of the milk protein or up to about 80% by weight of the milk protein; and as including at least about 99% by weight of the combined fats. As additional examples, separating the milk-plant fat composition may accordingly include forming the whey composition as including, as derived from the first amount of the milk composition and the second amount of the plant fat composition utilized in forming the milk-plant fat composition, less than about 30% by weight of the milk protein and less than about 5% by weight of the combined fats; or less than about 25% by weight or as little as about 20% by weight of the milk protein, and less than about 1% by weight of the combined fats.

Throughout this specification, the term “milk-plant fat-curd cheese” means a cheese curd resulting from the culturing of lactic acid-producing bacteria in a milk-plant fat composition. The reduction of the pH of the milk-plant fat composition that takes place during step [108] causes the formation of two phases in the milk-plant fat composition, including a curd and a dilute aqueous whey composition. In an example, the milk-plant fat-curd cheese and the dilute aqueous whey composition may be separated by passing the milk-plant fat composition through a suitable mechanical separator apparatus. For example, a centrifugal separator apparatus may be utilized. Examples of suitable centrifugal separator apparatus for separating the milk-plant fat-curd cheese from the dilute aqueous whey composition are disclosed in: Link U.S. Pat. No. 2,387,276 “Cream Cheese Manufacture,” issued on Oct. 23, 1945; and Strezynski U.S. Pat. No. 2,436,498 “Apparatus for Use in the Centrifugal Separation of Serum from Cheese Constituents,” issued on Feb. 24, 1948. The entireties of each of these two U.S. patents are hereby incorporated herein by reference. Suitable centrifugal separator apparatus may also be commercially available under the trade name “Westfalia Separator,” from GEA Westfalia Separator, Werner-Habig Strasse 1, Oelde 59302 Germany, website www.westfalia-separator.com. As an example, a mechanical separator apparatus may be selected having adequate throughput capacity so that the separation of the milk-plant fat-curd cheese from the whey composition at step [110] does not cause rate-limiting delays in the process [100]. In operating a mechanical separator apparatus to carry out step [110] of the process [100], the mechanical separator apparatus may be configured to control the moisture level in the milk-plant fat-curd cheese. For example, a backpressure valve in a centrifugal separator apparatus may be adjusted to provide such moisture level control. In an example, step [110] may include heating the milk-plant fat composition to an elevated temperature in a degassing vessel to “break” the curd from the dilute aqueous whey composition before passing the milk-plant fat composition through a mechanical separator apparatus. For example, the milk-plant fat composition may be heated to an elevated temperature within a range of between about 160° F. and about 175° F., or to a temperature of about 170° F. In another example, step [110] may include then directing the dilute aqueous whey composition into a holding tank for further utilization.

As another example, the culturing of the lactic acid-producing bacteria in the milk-plant fat composition at step [108] may include forming the dilute aqueous whey composition as being a dilute aqueous acid whey composition; and the process [100] may include recovering the dilute aqueous acid whey composition, for example from the holding tank, after separating the milk-plant fat-curd cheese from the dilute aqueous acid whey composition at step [110]; and the recovered dilute aqueous acid whey composition may then be recycled as a component of the milk composition at step [104]. Suitable processes for recycling the dilute aqueous acid whey composition are disclosed in commonly-owned U.S. patent application Ser. No. 13/037,292, filed on Feb. 28, 2011, entitled “Processes For Making Cheese Products Utilizing Denatured Acid Whey Proteins,” the entirety of which hereby is incorporated herein by reference.

In an example, step [110] may include directly acidifying the milk-plant fat-curd cheese after the separating, to further reduce the pH to being within a range of between about 4.7 and about 4.6. As an example, the direct acidification may be carried out by combining an appropriate amount of an edible acid together with the milk-plant fat-curd cheese after completing the separating. The edible acids that were discussed earlier in connection with examples of direct acidification of the milk-plant fat composition that may be included after completing the bacteria culturing in step [108] may likewise be utilized for direct acidification of the milk-plant fat-curd cheese in step [110]. Direct acidification of the milk-plant fat-curd cheese, if included in step [110] after completing the separating, may be carried out, for example, in a set tank internally equipped with a scraped surface agitator to ensure rapid and thorough mixing together of the edible acid and the milk-plant fat-curd cheese. Agitation may, as an example, be discontinued upon reaching a selected final pH for the milk-plant fat-curd cheese within the range of between about 4.7 and about 4.6, to avoid excessively shearing and possibly breaking down the viscosity of the milk-plant fat-curd cheese. The direct acidification may generally be carried out at the temperature that was selected for separating the milk-plant fat composition at step [110], for example. As further examples, the direct acidification may be carried out at a temperature within a range of between about 155° F. and about 170° F.; or at a temperature of about 165° F. In another example, the direct acidification may be carried out at a relatively reduced temperature, such as a temperature within a range of between about 75° F. and about 60° F. However, the viscosity of the milk-plant fat-curd cheese may generally increase as the temperature is reduced, which may impede mixing together of the edible acid and the milk-plant fat-curd cheese. Accordingly, carrying out the direct acidification at a temperature below about 60° F. may cause the milk-plant fat-curd cheese to have a lumpy texture. Cooling can be effected, for example, using jacketed tanks containing a glycol refrigerant maintained at a selected temperature to withdraw heat from the milk-plant fat composition in the tank.

In a further example, step [110] of the process [100] may include combining the milk-plant fat-curd cheese together with a stabilizer and a salt. The milk-plant fat-curd cheese, stabilizer, and salt may be, as an example, combined together at an elevated temperature, such as about 165° F. Examples of types of stabilizers that may be utilized include gums and salts. Accordingly, a suitable salt may also serve as a stabilizer herein. Suitable gums include, for example, locust bean gum, xanthan gum, guar gum, gum Arabic, and carageenan. Suitable salts include, for example, sodium chloride and potassium chloride. As an example, the stabilizer may include K6B493, which is a milled, dry product that may be commercially available from CP Kelco US, Inc., 1313 North Market Street, Wilmington, Del. 19894-0001. In further examples, the stabilizer may include a blend of xanthan gum, locust bean gum and guar gum. Suitable gum compositions may be commercially available from TIC Gums Inc., Belcamp, Md. For example, a stabilizer may be combined with the milk-plant fat-curd cheese at a concentration, by weight, being within a range of between about 0.25% and about 0.45% of the milk-plant fat-curd cheese; or at a concentration, by weight, being within a range of between about 0.3% and about 0.4% of the milk-plant fat-curd cheese.

As another example, step [110] of the process [100] may include mixing together the milk-plant fat-curd cheese, salt and stabilizer. The mixing may, for example, further include homogenizing the milk-plant fat-curd cheese, salt and stabilizer by subjecting the mixture simultaneously to an elevated pressure and temperature. As examples, the homogenization procedures and conditions discussed earlier in connection with step [104] of the process [100] may be utilized. Step [110] of the process [100] may further include packaging the milk-plant fat-curd cheese while still at an elevated temperature, and then reducing the temperature of the milk-plant fat-curd cheese to a suitable refrigeration temperature, such as, for example, a temperature within a range of between about 34° F. and about 38° F. In another example, step [110] of the process [100] may alternatively include reducing the temperature of the milk-plant fat-curd cheese to a suitable refrigeration temperature prior to packaging the milk-plant fat-curd cheese.

In a further example, step [110] of the process [100] may include adding a suitable preservative to the milk-plant fat-curd cheese to retard growth of bacteria, yeast and mold. For example, potassium sorbate, sodium benzoate, sorbic acid, ascorbic acid or nisin may be added. Nisin, for example, is a protein expressed by Lactococcus lactis. Further, for example, flavorings, condiments and the like may be added to the milk-plant fat-curd cheese.

In further examples, step [110] may include subjecting the milk-plant fat-curd cheese to a whipping process to modify the milk-plant fat-curd cheese to have a whipped, more easily spreadable consistency. Information as to suitable procedures for carrying out such whipping processes is disclosed in commonly-owned U.S. patent application Ser. No. 11/454,756, filed on Jun. 16, 2006, entitled “Cream Cheese Products and Methods of Making the Same,” the entirety of which hereby is incorporated herein by reference.

The process [100] may then end at step [112]. The resulting milk-plant fat-curd cheese includes a milk-plant fat composition having a first concentration by weight of milk protein and a second concentration by weight of combined fats including milk fat and plant fat; wherein a ratio of the first concentration divided by the second concentration is within a range of between about 0.19 and about 0.26, and wherein the milk-plant fat composition includes lactic acid-producing bacteria. As a result of conforming to the ratio as being within that range, the milk-plant fat-curd cheese generally has a creamy, smooth texture, and generally does not have a dry, grainy texture. As further examples, the ratio of the first concentration divided by the second concentration may be within a range of between about 0.20 and about 0.22; or may be within a range of between about 0.21 and about 0.22. In another example, the milk-plant fat-curd cheese may include a concentration by weight of milk fat of at least about 5%. As further examples, the milk-plant fat-curd cheese may include a plant fat derived from seeds or fruit of: soy, corn, canola, sunflower, safflower, olive, peanut, cottonseed, sesame, almond, apricot, avocado, coconut, flax, grapeseed, hazelnut, palm, palm kernel, pine, poppy, pumpkin, rice bran, tea, walnut, wheat, hemp, acai, cashew, chia, pecan, or hazelnut. As additional examples, the milk-plant fat-curd cheese may include lactic acid-producing bacteria being of a mesophilic strain that includes: Lactococcus-lactis-lactis-diacetylactis, Leuconostoc mesenteroides cremoris, Lactococcus-lactis-lactis, Lactococcus-lactis-cremoris, or Lactobacillus helveticus. In additional examples, the milk-plant fat-curd cheese may contain a concentration by weight of milk fat being within a range of between about 11% and about 16%; and a concentration by weight of plant fat being within a range of between about 10% and about 17%. The milk-plant fat-curd cheese generally has a viscosity and body comparable to that of conventional cream cheese. The process [100], particularly the culturing in step [108], may mitigate any strong flavor of the plant fat composition that is combined into the milk-plant fat composition. The process [100] generally facilitates forming milk-plant fat-curd cheeses as having an appealing flavor and good baking properties. Direct-set milk-plant fat products that may be combined together with the milk-plant fat curd cheeses are disclosed in the concurrently-filed and commonly-owned U.S. patent application entitled “Direct-Set Cheese,” the entirety of which hereby is incorporated herein by reference. Processes that may be utilized for combining the milk-plant fat curd cheeses with the direct-set milk-plant fat products are disclosed in the concurrently-filed and commonly-owned U.S. patent application entitled “Cream Cheese-Type Compositions,” the entirety of which hereby is incorporated herein by reference.

### EXAMPLE

A milk composition was formed by charging 11,000 pounds of water to a 3,000 gallon tank, heating the water to 128° F., and gradually mixing 2,200 pounds of condensed milk and 5,500 pounds of cream and 41,190 pounds of whole milk into the water with agitation. A plant fat composition was formed by charging 3,800 pounds of palm oil to a 3,000 gallon tank and heating the palm oil to 128° F. A milk-plant fat composition was formed by mixing together a first amount of 59,890 pounds of the milk composition and a second amount of 3,800 pounds of the plant fat composition, by gradually adding the plant fat composition to the milk composition. In forming the milk-plant fat composition, the first amount of the milk composition and the second amount of the plant fat composition as prepared with the above ingredients were allocated to and processed as a series of three batches through the 3,000 gallon tanks The total solids concentration of the milk-plant fat composition was selected as being about 18.5% by weight; and a ratio of the concentration of milk protein divided by the concentration of combined milk fat and plant fat was selected as being about 0.21. The milk-plant fat composition was subjected to high temperature short time pasteurization at 165° F. for 2-3 seconds; and was subjected to a 2-stage homogenization including a second stage at 500 PSI followed by a first stage at 2,000 PSI. The milk-plant fat composition was maintained at a bacteria culture temperature of about 82° F. and inoculated with a bulk culture of Hansen grade 608 mesophilic lactic acid-producing bacteria. After culturing the bacteria in the milk-plant fat composition reduced the pH to about 4.7, the composition was heated to about 170° F. to break the curd/whey and was then passed through a centrifugal separator, forming a milk-plant fat-curd cheese and a whey composition. The milk-plant fat curd cheese was combined with 245 pounds of a commercial salt/gum stabilizer blend. The milk-plant fat-curd cheese had a creamy, smooth texture and an appealing flavor.

While the present invention has been disclosed in a presently preferred context, it will be recognized that the present teachings may be adapted to a variety of contexts consistent with this disclosure and the claims that follow. For example, the process shown in the figures and discussed above can be adapted in the spirit of the many optional parameters described, to yield a variety of milk-plant fat-curd cheeses.

What is claimed is:

1. A process, comprising:
forming a milk-plant fat composition including a first amount of a milk composition that includes milk fat and milk protein, and including a second amount of a plant fat composition that includes plant fat, the milk-plant fat composition having a concentration by weight of total solids selected as being within a range of between about 17% and about 21%, and the milk-plant fat composition having a first concentration by weight of the milk protein and having a second concentration by weight of combined fats including the milk fat and the plant fat, wherein a ratio of the first concentration divided by the second concentration is selected as being within a range of between about 0.19 and about 0.26;
inoculating the milk-plant fat composition with lactic acid-producing bacteria;
culturing the lactic acid-producing bacteria in the milk-plant fat composition; and
separating the milk-plant fat composition, thereby forming a milk-plant fat-curd cheese, and a whey composition.

2. The process of claim 1, wherein the forming the milk-plant fat composition includes providing the milk composition as including aqueous, condensed, dry or reconstituted raw-, whole-, reduced-fat- or nonfat-milk, or cream.

3. The process of claim 1, wherein the forming the milk-plant fat composition includes providing the milk composition as including: a concentration by weight of milk fat being within a range of between about 52% and about 10%; and a concentration by weight of milk protein being within a range of between about 4% and about 2%; and a concentration by weight of water being within a range of between about 51% and about 36%.

4. The process of claim 1, wherein the forming the milk-plant fat composition includes providing the plant fat composition as including the plant fat as being derived from seeds or fruit of: soy, corn, canola, sunflower, safflower, olive, peanut, cottonseed, sesame, almond, apricot, avocado, coconut, flax, grapeseed, hazelnut, palm, palm kernel, pine, poppy, pumpkin, rice bran, tea, walnut, wheat, hemp, acai, cashew, chia, pecan, or hazelnut

5. The process of claim 1, wherein the forming the milk-plant fat composition includes forming the milk-plant fat composition as including a third amount of a concentrated milk protein source, the third amount being suitable for adjusting the ratio of the first concentration divided by the second concentration as being within the range of between about 0.19 and about 0.26.

6. The process of claim 1, wherein the forming the milk-plant fat composition includes selecting the second amount of the plant fat composition as being less than or equal to about 60% by weight of the milk-plant fat composition.

7. The process of claim 1, wherein the forming the milk-plant fat composition includes selecting the first amount of the milk composition as causing the milk-plant fat composition to have a concentration by weight of the milk fat being at least about 5% by weight.

8. The process of claim 1, wherein the forming the milk-plant fat composition includes providing the first amount of the milk composition at a first temperature being at least about 20 degrees Fahrenheit (° F.) above a melting point of the milk composition, and providing the second amount of the plant fat composition at a second temperature being at least about 20° F. above a melting point of the plant fat composition, and then combining together the milk composition and the plant fat composition.

9. The process of claim 8, wherein the forming the milk-plant fat composition includes carrying out the combining the first amount of the milk composition together with the second amount of the plant fat composition with a difference between the first and second temperatures being about 5° F. or less.

10. The process of claim 8, wherein the forming the milk-plant fat composition includes providing the second amount of the plant fat composition at the second temperature as being within a range of between a pasteurization temperature and a temperature being about 20° F. above the melting point of the plant fat composition.

11. The process of claim 1, wherein the inoculating the milk-plant fat composition with the lactic acid-producing bacteria includes inoculating the milk-plant fat composition with live and active lactic acid-producing mesophilic bacteria.

12. The process of claim 1, wherein the inoculating the milk-plant fat composition with the lactic acid-producing bacteria includes inoculating the milk-plant fat composition with live and active mesophilic bacteria of a strain that includes: Lactococcus-lactis-lactis-diacetylactis, Leuconostoc mesenteroides cremoris, Lactococcus-lactis-lactis, Lactococcus-lactis-cremoris, or Lactobacillus helveticus.

13. The process of claim 1, wherein the forming the milk-plant fat composition includes forming the milk-plant fat composition as having an initial pH; and wherein the forming the milk-plant fat-curd cheese and the whey composition includes carrying out the separating the milk-plant fat composition when the initial pH has been reduced to being within a range of between about 4.9 and about 4.5.

14. The process of claim 1, wherein the separating the milk-plant fat composition includes forming the milk-plant fat-curd cheese as including at least about 70% by weight of the milk protein and including at least about 95% by weight of the combined fats.

15. The process of claim 1, including combining together the milk-plant fat-curd cheese and an amount of an edible acid being suitable for reducing a pH of the milk-plant fat-curd cheese to being within a range of between about 4.7 and about 4.6.

16. The milk-plant fat-curd cheese made according to the process of claim 1.

17. A composition, comprising:
a milk-plant fat-curd cheese including a milk-plant fat composition having a first concentration by weight of milk protein and a second concentration by weight of combined fats including milk fat and plant fat;
wherein a ratio of the first concentration divided by the second concentration is within a range of between about 0.19 and about 0.26; and
wherein the milk-plant fat composition includes lactic acid-producing bacteria.

18. The composition of claim 17, including a concentration by weight of milk fat of at least about 5%.

19. The composition of claim 17, wherein the plant fat includes a plant fat derived from seeds or fruit of: soy, corn, canola, sunflower, safflower, olive, peanut, cottonseed, sesame, almond, apricot, avocado, coconut, flax, grapeseed, hazelnut, palm, palm kernel, pine, poppy, pumpkin, rice bran, tea, walnut, wheat, hemp, acai, cashew, chia, pecan, or hazelnut.

20. The composition of claim 17, wherein the lactic acid-producing bacteria are of a mesophilic strain that includes: Lactococcus-lactis-lactis-diacetylactis, Leuconostoc mesenteroides cremoris, Lactococcus-lactis-lactis, Lactococcus-lactis-cremoris, or Lactobacillus helveticus.
